(19) United States
(12) Patent Application Publication
(10) Pub. No.: US 2010/0163087 A1
(43) Pub. Date: Jul. 1, 2010

(54) Physical assistance device configurable into a walker/rollator, seat or transport chair

(76) Inventor: Douglas Catton, Sparks, NV (US)

Correspondence Address: WEIDE & MILLER, LTD., 7251 W. LAKE MEAD BLVD., SUITE 530, LAS VEGAS, NV, 89128, US

(21) Appl. No.: 12/655,060

(22) Filed: Dec. 21, 2009

Related U.S. Application Data
(60) Provisional application No. 61/203,872, filed on Dec. 29, 2008.

(51) Int. Cl. A61H 3/04; A61H 3/00

(52) U.S. Cl. 135/67

(57) ABSTRACT

A physical assistance device is configured as a walking aid and to support a user in a seated position. The physical assistance device may have a pair of spaced front legs and a pair of spaced rear legs connected to the front legs, and at least one handle supported by the pair of front legs, so as to have a front and a rear and an interior area in which a user may stand when walking when facing the front of the physical assistance device. The physical assistance device also comprises a seat with legs connected to the frame and movable between a seating position in which it is positioned at the interior area at the rear of the physical assistance device with a seating surface thereof facing the front of the physical assistance device, whereby a user may sit upon the seating surface while still facing the front of the physical assistance device, and a retracted position.

### RELATED APPLICATION DATA

This application claims priority to U.S. Provisional Patent Application Ser. No. 61/203,872, filed Dec. 29, 2008.

### FIELD OF THE INVENTION

The present invention relates to walking, seating and transport aids.

### BACKGROUND OF THE INVENTION

Many people suffer from ailments or injuries which make it difficult for them to walk unaided. If the ailment or injury is sufficiently severe, the person may be confined to a wheelchair.

However, in many other instances, the person merely needs a walking aid. One such aid is a cane. Canes do not offer a great deal of stability, however, and can be difficult to use.

A common walking aid that provides greater stability is the walker. Walkers generally comprise a frame or structure having two or more points of contact with the ground. The walker is designed to extend across the front of the user for engagement by both hands of the user. In this manner, the user is provided side-to-side stability. In addition, the user can lean down on the walker for support in standing. To allow a user to more easily move a walker with them, walkers are often supported by wheels. In such a configuration, a walker is commonly referred to as a “rollator”.

Sometimes a user of a walker needs to sit down to rest. This is relatively convenient if the user is close to a seating surface such as a chair in the home. However, a chair or the like may not be available, or the user may not have the strength to travel to the seat.

As one attempt to solve this problem, some walkers include a seating element. However, to provide support for the seat and/or make the walker usable when the user is not seated, the seats of such walkers all have very disadvantageous configurations. Most commonly, walkers which include seats have their seats located at the front of the walker facing rearwardly. When a user desires to switch between walking and sitting, this requires that the user attempt to turn around to sit down. When the user attempts to turn around, however, they lose the support of the walker. This often results in the user falling down and risking further injury, which is contrary to the original purpose of the walker for seating purposes.

### SUMMARY OF THE INVENTION

One aspect of the invention is a physical assistance device which may be configured as a walking aid and support a user in a seated position. In one embodiment, the physical assistance device has a pair of spaced front legs, a pair of spaced rear legs connected to the front legs, and at least one handle supported by the pair of front legs. So configured, the physical assistance device preferably has a front and a rear and an interior area defined by the frame between the spaced front and rear legs in which a user may stand when walking when facing the front of the physical assistance device.

The physical assistance device preferably also comprises a seat connected to the frame of the physical assistance device. The seat is movable between a seated position in which the seat is positioned at the interior area at the rear of the physical assistance device with a seating surface thereof facing the front of the physical assistance device, whereby a user may sit upon the seating surface while still facing the front of the physical assistance device, and a retracted position in which the seat does not prevent access to the interior area of the physical assistance device at the rear thereof In one embodiment, the physical assistance device may include one or more handles configured so that when the physical assistance device is used in its seated position, it may be used as a transport chair.

In one embodiment, the seat comprises a first seat portion connected to one of the rear legs and a second seat portion connected to the other of the rear legs. The first and second seat portions may be rotatably connected to the rear legs, permitting the first and second seat portions to rotate between the seated position and the retracted position.

The front and rear pairs of legs may be hingedly connected, permitting the physical assistance device to be moved between a collapsed and extended position. In addition, the legs may be supported by one or more wheels, swivel wheels or casters, permitting the physical assistance device to roll or turn.

In one embodiment, a seat control is provided which allows the user to control the position of the seat. The seat control may comprise a control which causes the seat to move from the retracted position to the seated position while the user is facing the front of the physical assistance device. Use of the same control or release of that control may cause or allow the seat to move back to its retracted position. The control may comprise a lever mounted to the handle(s) of the physical assistance device, the lever connected to the seat by a cable or the like.

Further objects, features, and advantages of the present invention over the prior art will become apparent from the detailed description of the drawings which follows, when considered with the attached figures.

### DESCRIPTION OF THE DRAWINGS

FIG. 1 is a perspective view of a physical assistance device of the invention with a seat portion thereof illustrated in a use position;

FIG. 2 is a perspective view of the physical assistance device illustrated in FIG. 1 in a folded position;

FIG. 3 is a side elevation view of a physical assistance device of the invention with a seat portion thereof in a retracted position and a user engaging the physical assistance device in a walking position;

FIG. 4 is a perspective view of the physical assistance device illustrated in FIG. 1 with a seat thereof in a use position and a user seated in the seat; and

FIG. 5 is a perspective view of the physical assistance device illustrated in FIG. 1 configured as a transport chair.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a user physical assistance device. The user assistance device is conveniently referred to herein as a walker/rollator in that one purpose thereof is to provide support to a user when the user is walking. As detailed herein, the physical assistance device is also preferably configured to support a user at one or more times in a seated, stationary position. As detailed, in such a position the physical assistance device may be used for simple seated support or may be used as a transport chair, such as to be rolled/guided by another party.

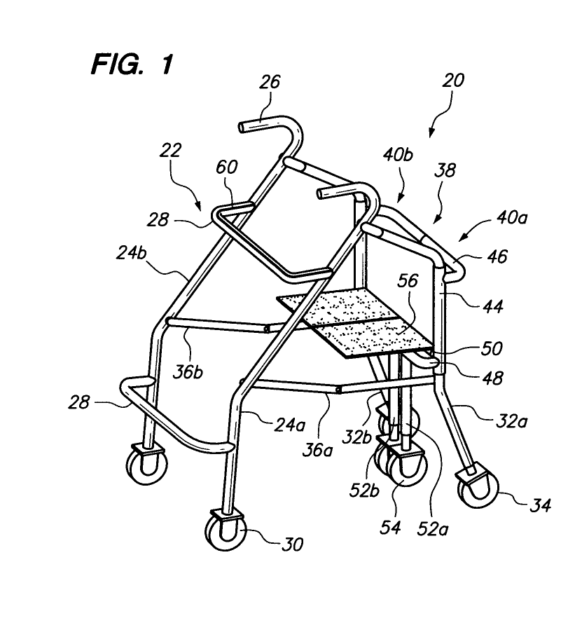

FIG. 1 illustrates one embodiment of a physical assistance device 20 in accordance with the present invention. In one embodiment, the physical assistance device 20 comprises a frame 22. The configuration of the frame 22 may vary. Preferably, the frame 22 is supported by at least two, more preferably three, and most preferably, at least four supports. As illustrated, the frame 22 comprises first and second (or left and right) front legs 24a,b.

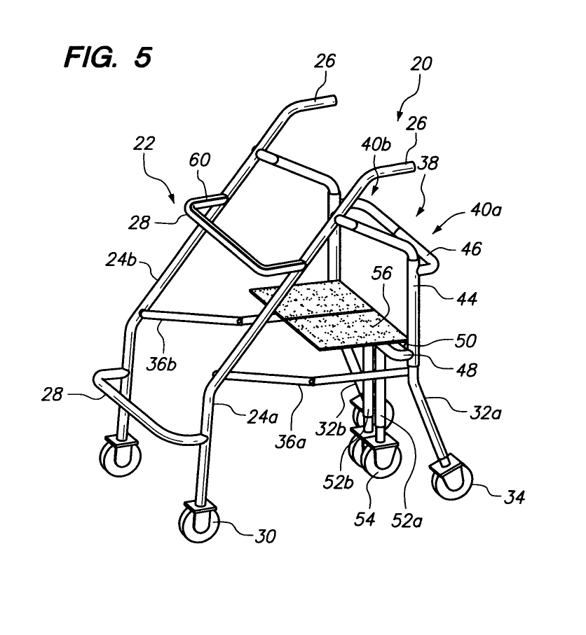

In one embodiment, each front leg 24a,b has a handle 26 located at a top end thereof The handle 26 may be connected to each front leg 24a,b, or as illustrated, be defined thereby. In the preferred embodiment, each handle 26 is located at a top portion of each front leg 24a,b, though they could be in other locations. The handles 24a,b may be oriented in various directions. As detailed herein, the handles 26 could face forward, as illustrated in FIG. 1, or rearward, as illustrated in FIG. 5. As indicated herein, the positions of the handles 26 may be changeable, such as depending upon the desired configuration of the physical assistance device 20.

The front legs 24a,b are spaced from one another. This spacing may vary, including depending upon the size of the user for which the physical assistance device 20 is intended. Preferably, the spacing causes the front legs 24a,b to be located approximately even to a user's shoulders/arms. One or more struts 28 may extend between the front legs 24a,b, thus securely connecting them into their desired spacing/location. For example, as illustrated, one strut 28 may be located near the top of the front legs 24a,b below the handles 26, and another strut may be located near the bottom of the legs 24a,b. Of course, the number of struts, their orientation and shape may vary.

In one embodiment, a wheel 30 is located at the bottom of each front leg 24a,b. The wheel 30 may be of a variety of types, such as simple axle, caster, swivel or the like. Further, the wheel may comprise a single wheel or multiple wheels. In other embodiments, the front legs 24a,b might also simply terminate (i.e. have an end without a wheel) or have a surface contacting foot or other element located at the end thereof.

As illustrated, the front legs 24a,b may extend upwardly from their bottom ends generally vertically, and then slope rearwardly towards their top ends. In this manner, when a user is engaging the handles 26 and they move their feet forwardly to walk, their feet do not impact the physical assistance device. In addition, as detailed below, the spacing of the front wheels 30 from rear wheels (detailed below) provides support to the physical assistance device 20.

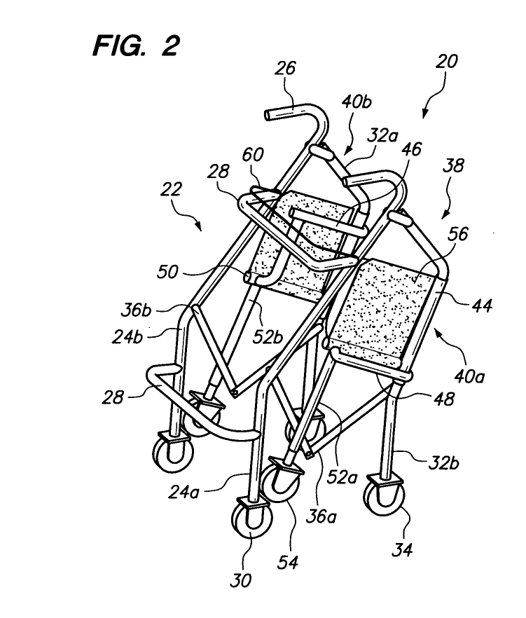

In one embodiment, the physical assistance device 20 also comprises a pair of rear legs 32a,b (i.e. first and second or right and left rear legs). In one embodiment, each rear leg 32a,b is attached to its corresponding front leg 24a,b, such as at a top end or portion of the rear leg 32a,b. As illustrated, this connection may be near the top of the front legs 24a,b beneath the handles 26. In addition, as illustrated in FIG. 2, the front and rear legs may be rotably or hingedly connected, such as via a hinge, thereby permitting the rear legs 32a,b to be folded inwardly towards the front legs 24a,b, in the manner detailed below.

So configured, the physical assistance device 20 generally has a pair of sides, a front and a rear. The front is generally closed, such as via the struts 28, while the rear is generally open. The frame of the physical assistance device 20 generally defines an interior area between the front and rear legs 24a,b and 32a,b from front to back, and by the pairs of legs at the sides. Because the rear of the physical assistance device 20 is generally open, a user can walk into the interior area of the physical assistance device 20 from the rear thereof. At that time, the user is generally located within the frame of the physical assistance device 20, thus providing stability to the user in both the front-to-rear and side-to-side directions.

Once again, a wheel 34 may be located at the bottom or second end of each of the rear legs 32a,b. The type and/or number of wheels 34 may again vary. Further, the wheels 34 could be replaced with feet or other elements.

When both the front and rear legs are fitted with wheels 30,34, the physical assistance device 20 includes a pair of front wheels and a pair of rear wheels. These pairs of wheels rotably support the physical assistance device. It will be appreciated that if the physical assistance device does not include wheels and is used to aid a user in walking, it may be simply referred to as a “walker”. However, if the physical assistance device includes wheels and is used to aid a user in walking, it may be referred to as a “rollator”, in accordance with the common parlance of these terms.

One or more of the wheels 30,34 may include a braking or locking mechanism, such as to prevent the physical assistance device 20 from rolling away.

As illustrated, the rear legs 32a,b may extend rearwardly from the front legs 24a,b and then downwardly, and then rearwardly again. In this manner, the front and rear wheels 30,34 are spaced from one another from the front to the rear of the physical assistance device 20, thus serving to provide substantial front to back stability to the physical assistance device 20.

To provide further support, side struts 36a,b may extend between the corresponding pairs of front and rear legs. In particular, a first side strut 36a may extend between the left side front and rear legs 24a,32a and a second side strut 36b may extend between the right side front and rear legs 24b,32b. As illustrated, these side struts 36a,b may be located approximately midway along the length of the legs. In order to permit folding or collapsing of the physical assistance device 20, each side strut may comprise first and second members which are rotatably or hingedly connected.

Most importantly, the physical assistance device 20 also comprises at least one seat 38. Preferably, the seat 38 is mounted to the frame of the physical assistance device 20 and is configured to be forward-facing so that a user can transition from standing to sitting and sitting to standing without having to turn around or otherwise change directions relative to the physical assistance device. At the same time, the seat 38 is preferably configured so that it does not impede the user's use of the physical assistance device as a walking aid.

In one embodiment, the seat 38 comprises a first seat portion 40a and a second seat portion 40b. In one embodiment, each seat portion comprises a seat frame and a seat surface. As illustrated, each seat frame comprises a mounting portion 44 which is preferably connected to one of the rear legs 32a,b. The mounting portion 44 is preferably rotatably mounted to its corresponding rear leg. In one embodiment, the mounting portion 44 may comprise a tube or sleeve which extends around the generally vertical middle portion of its corresponding rear leg 32a,b.

Each seat frame also preferably comprises a three horizontal supports 46,48,50. A first of the supports 46 may extend outwardly from near the top of the mounting portion 44. The second and third supports 48,50 may extend outwardly below the first, such as from near the bottom of the mounting portion 44.

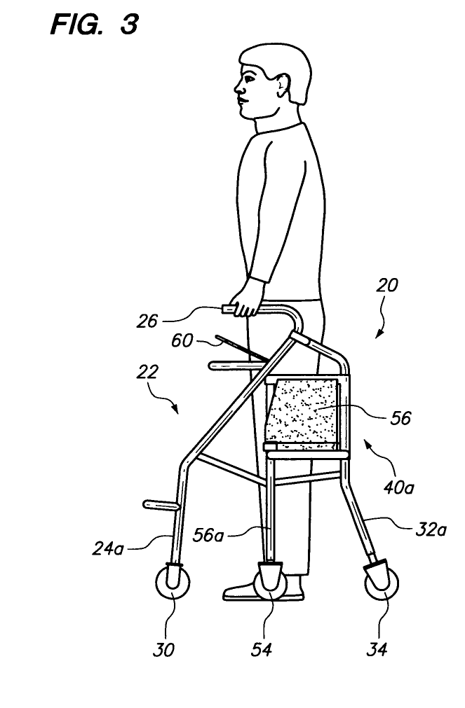

In one embodiment, each seat portion 40a,b also comprises a corresponding seat leg 52a,b. In one embodiment, each seat leg 52a,b extends downwardly from the top horizontal support 48 and engages the second and third lower supports 48,50, before extending to a wheel 54 (again, the configuration of the wheel or wheels may vary). As illustrated in FIGS. 1 and 3, these wheels 54 may provide additional support to the physical assistance device (i.e. six or more supports in the walking and/or seating position). In one embodiment, the wheels 54 may be slightly elevated above the other wheels 30,34 during use of the physical assistance device 20 as a walker/rollator, whereby the wheels 54 do not increase the drag of the device. However, when the physical assistance device 20 is used in the seating position, the weight of the user may cause then wheels 54 to come into contact with a support surface, thereby providing additional support.

As indicated, each seat portion 40a,b includes a seat support 56. In one embodiment, each seat support 56 is a generally planar support or body. As illustrated, the seat support 56 may be mounted to the second horizontal support 50 for rotating movement between a raised or vertical position and a lowered or horizontal position. In the horizontal position, the seat support 56 may be partly supported by the third or lower support 48 of the seat frame.

In a preferred embodiment, the various portions of the physical assistance device 20 are constructed from durable materials. For example, the legs, supports and struts may be constructed from metal tubing or bars. The seat supports may be constructed from molded plastic and/or be padded. The various portions of the physical assistance device might be painted or other surface ornamentation might be applied thereto. Further, rubber or foam grips or the like may be applied to the various portions thereof to aid the user in holding or gripping the physical assistance device.

The physical assistance device may include additional features such as brakes, height adjustment (such as a height adjustment for each leg or for the handles) or the like.

Additional aspects of the physical assistance device will be appreciated from the method of use and operation thereof.

Referring to FIG. 2, a user may store the physical assistance device 20 when it is not in use. At such time, the front and rear legs 24a,b and 32a,b may be folded or collapsed towards one another. This is facilitating by folding of the side struts 36a,b and by rotation of the rear legs 32a,b relative to the front legs 24a,b. In this manner, the profile or size of the physical assistance device 20 is reduced, such as for storage in a closet, for transport in the trunk of a car or the like.

Referring to FIG. 3, a user may utilize the physical assistance device 20 as a walking aid. At that time, the front legs 24a,b and the rear legs 32a,b are separated from one another and the side struts 36a,b are extended. In one embodiment, the side struts 36a,b may include a locking mechanism to lock the hinge thereof into a locked or fixed position, thereby maintaining the front and rear legs in their separated positions.

At this time, the seat portions 40a,b are preferably rotated to a first, retracted position, as illustrated in FIG. 3. At this time, the seat supports 56 are folded vertically up. The first seat portion 40a is rotated so that it is positioned outside of the first or left side of the physical assistance device 20 at the outside of the left side front and rear legs 24a,32a. The second set portion 40b is similarly rotated so that it is positioned outside of the second or right side of the physical assistance device 20 at the outside of the right side front and rear legs 24b,32b. When the seat portions 40a,b are in this position, they are spaced from one another and preferably do not obscure the rear portion of the physical assistance device, thus permitting the user to enter the rear of the physical assistance device 20.

The user faces the front of the physical assistance device 20 and grips the handles 26. The user can then walk forward with the support of the physical assistance device (the physical assistance device can conveniently roll on its wheels 30,34 as the user moves).

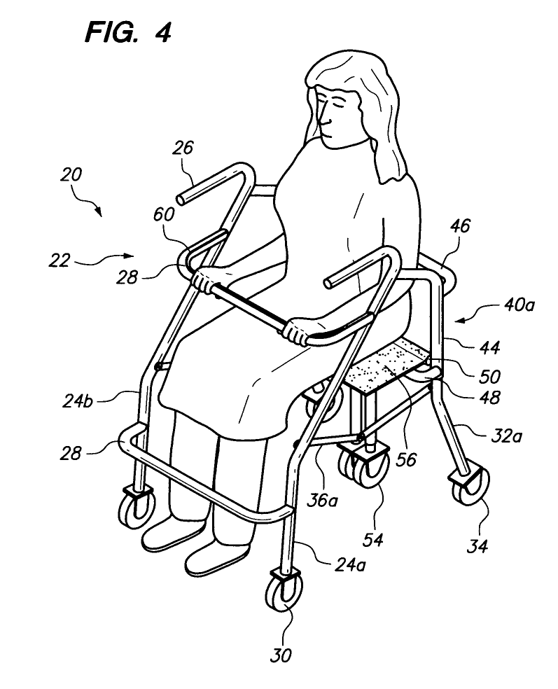

The user may also be supported by the physical assistance device 20 in a seated position. At this time, the user rotates the seat portions 40a,b into a second user or seated/seating position, as illustrated in FIGS. 1 and 4. As illustrated, when the seat portions 40a,b are moved into this position, they are moved proximate to one another, whereby the first or top supports 46 thereof combine to form a seat back.

The user moves the seat supports 56 downwardly. So rotated, the seat supports 56 are supported by the lower or third supports 50 of the seat portions 40a,b. The seat supports 56 are located adjacent to one another, thus forming a unitary seat. Notably, when the two seat portions 40a,b are rotated into their engaged position, the seat essentially spans the entire rear of the physical assistance device 20, thus providing a wide and stable seating area.

As also illustrated, at this time the seat legs 52a,b are rotated into an engaged position. In particular, the seat legs 52a,b extend under the seat to provide added support thereto.

Most importantly, the seat of the physical assistance device is configured so that it faces forwardly. Thus, when a user wishes to transition between walking to sitting, or sitting back to walking, the user does not need to turn around. Instead, when the user is walking and wishes to sit, the user may merely position the seat and then sit down into the seat while still facing forward. Likewise, in order to walk, the user simply stands up and moves the seat out to its retracted position. This is accomplished while the user remains facing forward.

In one embodiment, movement of the seat between its seated and retracted positions may be automated. For example, in one embodiment, the seat portions 40a,b may be biased to their first, retracted position. This may be accomplished with springs or other members which bias the seat portions 40a,b, causing them to rotate around to their retracted positions as illustrated in FIG. 3.

A seat control may be utilized for moving the seat to its engaged position. For example, a moveable grip, lever or bar 60 may be mounted to the physical assistance device 20, such as adjacent the top-most strut 28 (as illustrated in FIGS. 3 and 4). The seat control may be linked to the seat portions 40a,b, such as with one or more cables. Movement of the seat control, such as rotation of the grip or compression of the lever or bar 60, may pull the one or more cables, thus pulling the seat portions 40a,b into their engaged positions as illustrated in FIG. 4. The seat portions 40a,b may remain in that position until the seat control is released. In another embodiment, once the seat portions 40a,b are moved into their engaged position, they may be retained in that position with a user-controlled lock until the user is done using the seat. At that time, the user may release the lock, whereupon the biasing mechanism may move the seat portions 40a,b back to their retracted positions.

In one embodiment, the physical assistance device 20 may include a locking device to securely connect the seat portions 40a,b when the seat is moved into its engaged position. A wide range of means may be used to secure, lock or otherwise connect the seat portions 40a,b together. For example, a latch may be connected between the first supports 46 or the seat supports 56 of the seat portions 40a,b. In another embodiment, the first supports 46 or the seat supports 56 might comprise mating protections and detents that selectively engage one another. As one example, one seat portion 56 might have a protection or lock that can swivel outwardly into engagement with a slot in the other seat portion 56. So connected with such a lock, the seat portions 40a,b are preferably prevented from rotating or moving out of position without being unlocked first.

In one embodiment, the physical assistance device 20 of the present invention may be used as a transport chair. Namely, the physical assistance device may be configured to both support a user in a seated position and permit an operator to move or control the transport chair. For example, in one embodiment, the handles 26 may be elongated and rotatable. Thus, when the physical assistance device 20 is being used to support a user in a seated position, as illustrated in FIG. 5, the handles 26 may be rotated into a reverse position in which they extend rearwardly (instead of forwardly, as illustrated in FIG. 1). This would allow another party to stand behind the physical assistance device and grasp the handles 26 to push and/or steer the physical assistance device. In another embodiment, the physical assistance device might include an additional handle or handles (i.e. secondary to the handles 26), such as a set of handles extending from the first seat supports 46 that might be grasped by a user. Such handles might be retractable or otherwise move between a position in which they extend outwardly for use and a retracted position during non-use (so that they do not protrude from the physical assistance device undesirably).

Of course, the physical assistance device of the present invention may have other configurations. Most importantly, the physical assistance device is both configured as a walking aid and is configured to support the user in a seated position without the user having to turn around to be seated. Thus, for example, the seat portion of the physical assistance device might have other configurations and still having this desired configuration. For example, their might be a single seat portion which is hinged at one side of the physical assistance device. This single seat portion might rotated between a retracted position and a seated position in which it extends across the entire rear of the physical assistance device. It is also possible for the seat portions to have other configurations and to be mounted to the frame of the physical assistance device in other manners.

It is also possible for the one or more seat portion to move between other retracted positions. For example, the seat portions might fold or rotate from the rear of the physical assistance device into other positions.

It is also be appreciated that the physical assistance device might have other elements, including other supports, legs and the like. For example, for further configuration of the physical assistance device as a transport chair, the physical assistance device might include a pair of removable feet/leg supports that the user may rest their feet or legs upon in a raised position on while they are pushed by another person.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A physical assistance device which may be configured as a walking aid and support a user in a seated position, comprising:
a physical assistance device frame comprising:
a pair of spaced front legs;
a pair of spaced rear legs connected to said front legs; and
at least one handle supported by said pair of front legs;
said physical assistance device having a front and a rear and an interior area defined by said frame between said spaced front and rear legs in which a user may stand when walking when facing said front of said physical assistance device; and
a seat connected to said frame of said physical assistance device, said seat movable between a use position in which it is positioned at said interior area at said rear of said physical assistance device with a seating surface thereof facing said front of said physical assistance device, whereby a user may sit upon said seating surface while still facing said front of said physical assistance device, and a retracted position in which said seat does not prevent access to said interior area of said physical assistance device at said rear thereof.

2. The physical assistance device in accordance with claim 1 wherein said seat comprises a first seat portion connected to one of said rear legs and a second seat portion connected to the other of said rear legs.

3. The physical assistance device in accordance with claim 2 wherein each seat portion comprises a seat frame, a seat surface and at least one seat leg.

4. The physical assistance device in accordance with claim 1 wherein said first and second seat portions are rotatably connected to said rear legs, permitting said first and second seat portions to rotate between said use position and said retracted position.

5. The physical assistance device in accordance with claim 1 wherein said front and rear pairs of legs are hingedly connected, permitting said physical assistance device to be moved between a collapsed and extended position.

6. The physical assistance device in accordance with claim 1 wherein said front and rear legs are each supported by at least one wheel and wherein said seat is supported by at least one seat legs which is supported by at least one wheel.

7. A physical assistance device which may be configured as a walking aid and support a user in a seated position, comprising:
a physical assistance device frame having at least three supports and having a front and a rear; and
a seat connected to said frame of said physical assistance device, said seat movable between a use position in which said seat is configured to support a user facing said front of said physical assistance device, and a retracted position.

8. The physical assistance device in accordance with claim 7 wherein said seat comprises first and second seating portions, said first and second seating portions spaced from one another when said seat is in said use position and said first and second seating portions positioned adjacent one another to define a seating surface when said seat is in said use position.

9. The physical assistance device in accordance with claim 7 wherein said frame of said physical assistance device has a generally closed front and a generally open rear, said seat in said use position positioned at said rear of said frame.

10. A method of using a physical assistance device comprising:
facing a front of said physical assistance device in a standing position to walk with the aid of said physical assistance device;
moving a seat portion of said physical assistance device from a retracted to a use position while continuing to face said front of said physical assistance device; and
sitting upon said seat portion of said physical assistance device while facing said front of said physical assistance device.

11. The method in accordance with claim 10 including the step of using said physical assistance device as a transport chair by rolling said physical assistance device while said user is seated in said seat portion.
